(19) United States
(12) Patent Application Publication
(10) Pub. No.: US 2013/0080911 A1
(43) Pub. Date: Mar. 28, 2013

(54) PERSONALIZING WEB APPLICATIONS ACCORDING TO SOCIAL NETWORK USER PROFILES

(71) Applicant: Reinhard KLEMM, Basking Ridge, NJ (US)

(72) Inventor: Reinhard KLEMM, Basking Ridge, NJ (US)

(73) Assignee: Avaya Inc., Basking Ridge, NJ (US)

(21) Appl. No.: 13/368,749

(22) Filed: Feb. 8, 2012

Related U.S. Application Data
(60) Provisional application No. 61/539,673, filed on Sep. 27, 2011.

(51) Int. Cl. G06F 3/01

(52) U.S. Cl. 715/745

(57) ABSTRACT

Systems, methods, and non-transitory computer-readable storage media for personalizing applications, such as web applications, based on social networking data. A system configured to practice the method first identifies a user of an application, such as by requesting the user to log in to or create a user profile. The system optionally requests authorization from the user to access the social networking data, such as if all or part of the social networking data is private. The system can cache the social networking data in order to save bandwidth or keep requests within the terms of service of a social networking API. The system can assign the user into a user category based on the social networking data, and customize a user interface of the application based on the social networking data and/or the user category by adjusting at least one of location, size, and appearance of a user interface element.

### PRIORITY CLAIM

This application claims priority to U.S. Provisional Patent Application No. 61/539,673, filed 27 Sep. 2011, the contents of which are incorporated herein by reference in their entirety.

### BACKGROUND

1. Technical Field

The present disclosure relates to user interfaces and more specifically to personalizing user interfaces based on social network user profiles.

2. Introduction

Especially in the last decade, a significant amount of research has been devoted to the personalization of software and in particular of Web applications, encompassing applications that load user interfaces over a network into users' Web browsers. The user interfaces can range from simple HTML pages to complex thin clients, and the server-side part of the application can range from simple URL/resource mappings on a Web server to full-fledged enterprise software systems.

There is no consistent definition of the term personalization in the context of Web applications or beyond. In one definition, personalization of a user interface includes any action that makes the Web experience of a user personalized to the user's tastes and/or preferences. The problem with this approach is that a website must implement a framework for personalization, a user must be aware that personalization is an option, and then the user must manually personalize or enter preferences for each of an entire host of websites. These hurdles present a significant barrier to widespread personalized user interfaces.

Further, a large amount of research has been devoted to personalizing Web applications. Many commercial providers, from online shopping portals to entertainment services, have deployed personalized web applications that attract millions of users. In most of these applications, personalization is mostly internal and transparent to the user, with an additional small amount of explicitly gathered data about the user's persona. Despite the promise and success of these research and commercial systems, however, a number of challenges have limited the attained degree of personalization. Therefore, personalization of Web applications has not reached its full potential.

### SUMMARY

Additional features and advantages of the disclosure will be set forth in the description which follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Personalization of software in general and of web applications in particular promises many benefits for software providers as well as end users. Personalizing web applications can create a stronger emotional bond between end users and the application, facilitate use of the web applications, and enhance their effectiveness for users and the provider. In recent years, public and private social networks have proliferated and attracted a large number of users. Consequently, the amount of personal data that users have voluntarily placed online, including social network user profiles, has exploded. Social network user profiles constitute an as-of-yet untapped resource for personalizing Web applications and other software. Disclosed herein is a programming platform for enabling the personalization of web applications or other network-enabled applications according to users' profiles on a public and/or private social network. The platform emphasizes ease-of-use, flexibility, and general applicability across application domains.

Although some of the examples discussed herein involve Web applications, the same principles can be applied to virtually any other application with a user interface and access to social networking data either online or offline. Web interfaces were selected for the examples because Web platforms greatly facilitate technical execution of the customized user interfaces and explanations thereof.

Further, personalization can include actions taken by the Web application provider, often a business, to change the experience of a user based on the user's persona and context but not necessarily to the user's taste. This definition allows an application provider to generate personalized user interfaces for a Web (or other) application regardless of users' tastes and whose primary intention is to support a goal of the provider. Examples of such goals are reducing operational expenses, increasing product sales, more accurately presenting products and services that have a high degree of variability across the targeted customer base, and abiding by laws that govern the products or services rendered.

Consider, for example, a hypothetical Web application that acts as a storefront for an online pharmacy. Personalization of the storefront may be based on insights that the application gains about users' age, gender, location, income, work history, hobbies, and circle of friends. The outcome of the personalization may be an inclusion or omission of displayed medications based on local laws, gender, or age. A personalized interface can further visually emphasize more expensive products for users that are perceived to be more affluent.

The persona of a user can include the set of all discernible characteristics that describes this user up to the given time of observation. Essentially, the persona can encompass all that is discoverable, inferable, and/or learnable about this user, from past to present. The terms user context (or personal context) and user profile are related to persona. User context refers to the user's physical and abstract environment including locality, ambient lighting, surrounding culture, and laws by which the user has to abide. User profile includes a subset of the persona and denotes the collection of characteristics that are either completely static or have a low dynamicity. Highly static elements of a user persona are gender, birthday, hometown, name, family relationships, etc. Characteristics with a typically low dynamicity include the mailing address, hobbies and interests, work history, and personal relationships. At the other extreme in the spectrum of dynamicity of user characteristics are elements that can change often such as current mood, activity, hunger, and location.

A personalized web application can acquire knowledge of its users' personas and contexts through some means and offer variability in the content, appearance (or look and feel), and functionality of its user interface according to user personas and contexts. The application may make additional use of its knowledge of user personas and contexts outside the user interface and thus beyond personalization, for example, for reporting purposes. The various incarnations of the user interface of a personalized web application does not require a one-to-one relationship with users. For example, a personalized web application may show an identical user interface to all female users, while showing a different, identical one to all male users. Similarly, subcomponents of the user interface may incorporate small or substantial differentiations across the user base. Obviously, the more knowledge the application can gather about user personas and contexts, the more the application can differentiate the user interface. However, a thorough differentiation for each user based on detailed knowledge of the user, if available, often requires substantial development effort with few advantages. Even limited personalization can be valuable.

A personalized web application can collect user persona and context elements internally and transparently to the user, such as e-commerce Web sites that employ Web usage mining where the application monitors a user's access to the application and interaction with the application. Such an application can, for example, adjust the user interface according to the form factor and type of the user's Web browser on a PC, tablet computer, smartphone, etc., and produce personalized content including localized product offerings and product recommendations based on browsing history. The system can collect other user persona and context elements explicitly by prompting the user to enter relevant data. E-commerce Web sites, for example, routinely collect users' names, shipping addresses, and payment information explicitly. Some personalized web applications can rely on externally collected user persona and context elements. For example, softphone clients in enterprise communication systems can display users' availabilities for phone calls, inferred from calendar and presence information that the communication systems collect from external calendaring and presence applications.

Disclosed herein is an easy-to-use, general-purpose personalization programming platform. This platform acquires detailed external user profiles from social networks and programmatically supports profile-based personalization of Web applications. One implementation of the platform uses only user profiles in the personalization process. However, other implementations can include one or more social network items that can be attributed to individual users that are not part of user profiles, such as user posts, comments, friends, “likes”, etc. One example use of such additional, non-profile items is a company's personalized Web application that discovers that a user has been complaining in social network posts about a specific product from the company. The personalized Web application can therefore include a “May we help you with . . . ?” button that allows the user to speak to a company representative about this issue. Another example use is a company's personalized Web application retrieves users' friends through the platform. If a given user has a small number of friends, the application can include some additional functionality that allows the user to join some online social groups and thus make new friends. In another example use, the system analyzes the Facebook “likes” or Google+ thumbs-ups for Web/social network pages, products, services, concepts, groups, forums, etc., as retrieved by the platform and made available to a personalized application, in order to more accurately determine the predilections and preferences of users and market products and services to users accordingly.

This personalization platform can complement existing personalization techniques and increase the degree, extent, scope, and usefulness of Web application personalization. This approach shifts the complexity in personalizing Web applications from acquiring data about users to building application variations for different users or user groups based on a wealth of user profile data.

Disclosed are systems, methods, and non-transitory computer-readable storage media for personalizing application user interfaces based on social networking data. A system configured to practice the exemplary method first identifies a user of an application, such as by requesting the user to log in to or create a user profile. Alternatively, the system can identify the user based on a cookie, an existing session, a browser ‘fingerprint’ that uniquely identifies a particular browser, a network address, other identifying information, and/or a combination thereof.

The system optionally requests authorization from the user to access the social networking data, such as if all or part of the social networking data is private. The system can request this authorization when a user creates a user profile, for example, and rely on that authorization for subsequent personalization efforts. The system can also request this authorization from the user upon the first attempt by the system to personalize the user interface. The system retrieves social networking data about the user, such as through a social network API, cache, a ‘scraper’ that extracts information from a publicly available social networking source, and/or social networking aggregator. Other sources of information can also be used. When the system receives this social networking data, it can proceed to cache the social networking data in order to save on bandwidth and/or to keep traffic or requests within the terms of service of a social networking API.

The system can assign the user into a user category based on the social networking data, and customize a user interface of the application based on the social networking data and/or the user category by adjusting at least one of location, size, and appearance of a user interface element. The user interface element can be a non-advertising layout element including text, font, font size, an image, a color, a thickness, position, arrangement, orientation, transparency, and/or any other attribute of a displayable user interface element. The system can customize the user interface by mapping custom variables based on the social networking data.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example architecture for a personalization programming platform;

FIG. 3 illustrates an exemplary flow for performing personalization;

FIG. 4 illustrates an example personalized customer service widget;

FIG. 5 illustrates a flow for navigating an example personalized customer service menu; and

FIG. 6 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

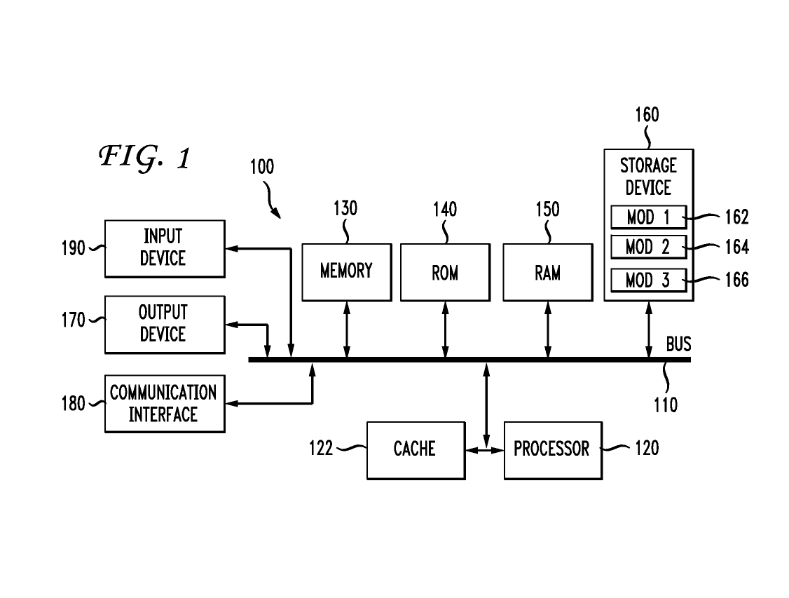

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output system (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod 1 162, Mod 2 164 and Mod 3 166 which are modules configured to control the processor 120. These modules may be stored on the storage device 160 and loaded into RAM 150 or memory 130 at runtime or may be stored as would be known in the art in other computer-readable memory locations.

Having disclosed some components of a computing system, the disclosure now returns to a discussion of customizing and personalizing user interfaces based on social networking data. One of the biggest challenges in developing a personalized web application is acquiring accurate data about users. Depending on the exact purpose of the personalization, different types of static and dynamic user persona and context data may be required. Explicitly involving a user in the procurement of the necessary data is very undesirable, for a number of reasons. First, prompting the user for extensive data input results in effort and inconvenience, and may dissuade the user from adopting the application or taking full advantage of features offered by personalization. The user may also choose to skip or cancel the data collection, and important user persona or context elements may remain unknown. Second, these user tendencies are even more likely if a large number of personalized web applications prompt the user for the same information. The effort and time necessary for users to work with personalized web applications may well outweigh the perceived benefits of the applications and lead to a broad rejection of the concept by users. Third, transparently detecting changes in a user's persona is difficult, and prompting the user for manual updates on a regular basis may aggravate the first and second issues. Fourth, user-entered information may be less accurate than desired because the effort in entering the information may tempt the user to become careless during data entry. As the user responds to the prompts for information, an underlying distrust of the application's intent in prompting the user for all this personal information may surface and may make the user deliberately enter incorrect information.

User persona data should be stored securely, safely, and efficiently, which is non-trivial. For all these reasons, personalized web applications have traditionally relied on transparently collected persona and context data with a short-term validity. For example, many e-commerce Web applications record search terms recently entered by the user or monitor the user's recent navigation through their Web pages, mine these interactions with the Web application, and map them to personalized context such as recommendations for additional or alternative products and services. When the user enters new search terms or changes the navigational path, these Web applications change the personalized content accordingly. The user often benefits from this type of personalization because it narrows a confusingly large and, for the user, mostly irrelevant number of products or services to a manageable and likely relevant subset. The business benefits because the user is less likely to abandon the product search without a purchase. Web usage mining and other forms of transparently collecting user persona and context elements can therefore be highly valuable for the user and for the provider of the personalized web application.

However, less dynamic user persona elements may be just as useful in personalizing the appearance, content, and functionality of Web applications. Examples of such elements are name, language, age, birthday, address, time zone, gender, education, work history, expertise, disabilities, affiliations, and hobbies. Some examples are provided of the countless possibilities for personalizing elements of Web applications based on user profile information and/or other information available about the user, such as social network posts, number of friends, a list of places in to which the user has checked in, account metadata describing how frequently and from where the user logs in to the social network, the types of friends or other social connections the user has, and so forth. This information can even include differences between data in a public-facing profile and data in a more private profile for close friends. The system can even glean information about the user based on social networking data that is not explicitly disclosed. For example, the system can infer, based on a particular style of writing or vocabulary, an ethnicity, demographic, level of education, and so forth.

A first example of a simple personalized application element is a greeting by name and depending on the current time in the user's time zone (“Good evening, Jane!”). If today is the user's birthday, the application can change the greeting accordingly. In a second example, the web application presents the entire textual content to the user automatically rendered in the user's preferred language. As a third example, if the user is older than some threshold or has a vision impairment, the application can automatically enlarge the font size in the application's Web user interface for easier readability. On the flip side, an e-commerce Web application can hide all paid products and services for children and present them with free resources, where the definition of “children” depends on the local laws in the user's location. In a fourth example, a business Web application displays the address of a newly opened store location near the user's home. A restaurant chain that wants to draw office workers at lunch time could offer a personalized web application that displays its address near the user's work place, even when the office workers are not at work and may be accessing the web application via a mobile device or at home.

In a fifth and perhaps more extreme example, the entire look and feel and content of the user interface of a Web application for an online electronics store can be changed according to the customer's user profile. A 20 year old, female, English-speaking high-tech enthusiast who is an electrical engineering student might see a user interface that is rendered in English, contains many buttons for quickly accessing a plethora of product segments for high-tech enthusiasts and/or advanced product options on the Web site. The web site can adapt to incorporate a fashionable, youthful color and layout scheme with a high-tech appearance, use a techy Terminal font, omit a link to a self-help Web page titled “How to operate my new smartphone” and instead offer a link to a Web page titled “How to root my new smartphone”, and display a promotion for a discounted mobile phone contract for students. On the other hand, the 70 year old, male, Spanish-speaking, affluent, professional poet who is an avid listener to classical music and has no professed affinity to technology might see a user interface with Spanish text, subdued colors, a clean, elegant, and orderly view with links to just a few product categories, plus one link to “More products”, a calligraphy font, a promotion for a high-end audio receiver, as well as a link to a Web page “Set up your new audio equipment in 10 minutes or less”.

The web application can personalize customer service options by offering different communication modalities to connect a customer with customer service representatives: email, text chat, voice calls, and video chat. Different communication modalities incur different costs for the customer service operation, with email being the cheapest and video chat being the most expensive. The application could mine the customer's user profile to estimate the value that this customer brings to the business. If the customer has no prior history of patronage with this business, inspecting the customer's profession, education, interests, place of residence, and other user profile elements can be especially helpful in estimating the customer's value. For low-value customers, the application may enable email, text chat, and voice calls, and place access to these communication modalities in an inconspicuous location in the user interface. The application can present a high-value customer, on the other hand, with a “Can we help you? Click here to start a video chat!” button right after the customer has launched the application.

One key feature of most social networks is a user profile, and most social networks offer an application programming interface (API) that provides access to user profiles after proper user authorization. To these applications, the social network represents, among other things, an external application-independent and domain-independent user profile manager. The subscribers of the social network typically have a strong interest in keeping their user profiles up-to-date because a well-maintained profile is crucial for the accurate self-representation in an online social fabric and thus vital to the users' goals for being part of the social network. A user is likely to update her photo album in the social network after a vacation or festivity, the place of residence after a move, education history after receiving a degree or diploma, work history after changing jobs, the list of favorite movies and books, interests and hobbies, activities, relationship details, and so on.

By accessing a user profile in the social network, an application can thus gain relatively accurate insights into the user persona without having to prompt the user for such information and without the burden of securely, safely, and efficiently storing user profiles. Furthermore, since the user profile is managed externally, every application can access it the same way and benefit from it, so long as the user provides authorization for the application to access their user profile on the social network. This is the key motivation for our personalization programming platform 3P. However, one potential pitfall of mapping user profile elements to personalized content, appearance, or functionality is misunderstanding some aspects of the user during such personalization can alienate the user. If, in the fifth example above, the application mistakenly identifies the 70 year old poet as affluent and in reality he is a starving artist, promoting expensive audio equipment is misplaced and may send the poet to a competing business. In the first example above, congratulating a user on her birthday may backfire if she prefers not to be reminded of advancing age.

Some users may become suspicious when the Web application asks for access to the user profile and therefore disallow it, thus making personalization based on a user profile impossible or very difficult. Yet others may allow it but experience a creepy sensation if personalization is very obvious and is perceived as invading the user's privacy or even threatening. Proclaiming “We know where you live, where you work, and where your children go to school!” may be well intentioned but could be perceived as a subtle threat or potential risk to the user.

A programming platform for personalizing content, interfaces, and other aspects of web and other applications can support the rapid development of web and other applications based on user profiles stored in external social networks.

This approach can provide flexibility and simplicity. Many personalization platforms may be powerful but are also difficult to learn. The effort required to master one of these platforms seems to pay off only if the same development team builds many personalized web applications on the same platform. Other personalization systems are easier to learn but are designed for a specific application in a specific domain. The approaches set forth herein provide a common programming platform that enhances developer productivity and facilitates application personalization across all Web application domains, thereby reducing the need for each development team to build its own ad hoc personalization software that is project-specific and function-specific. Programmers who have used the platform for one application can easily build other applications on the platform without additional learning or training.

This approach delivers a maximum amount of functionality across all web application domains and other application domains with a minimum amount of required learning, i.e., flexibility and simplicity. The principle of using external social network profiles to personalize applications has broad applicability across different application domains and personalization needs and thus supports platform flexibility. In the interest of simplicity, no special-purpose personalization language is required and programmers can continue using established web development languages and/or other languages with a few modifications and additions including a small and simple API. The examples set forth herein illustrate the flexibility of the platform in extending web applications coded in HTML, JavaScript, CSS, and Java. For practical reasons, the examples provided do not provide the same personalization mechanisms in other languages, but one of skill in the art will appreciate how to generalize these concepts.

One function of the personalization programming platform is to acquire user profiles from a social network and to map them to objects, such as Java objects. The objects can be available to the personalized web application in a simple and efficient way. Because many data points in a user profiles change only infrequently, a caching mechanism for user profiles can increase the efficiency of repeat profile retrieval and can be incorporated in the platform. Personalization of a Web application can continue beyond loading the user interface into the user's browser. Whenever the application regenerates parts of or the entire user interface, when triggered by user input (button clicks, hyperlink clicks, etc.) or asynchronously (Ajax), the application can personalize the new interface components and therefore access the user profile again. User profile caching is not only important for enhancing platform efficiency but also for avoiding any limits on the number of accesses to the social network API that the social network provider may impose.

The higher the degree of personalization in a Web application without explicit user involvement is, the higher the risk is to perform a counterproductive personalization. Using outdated user profile data in the personalization process aggravates this risk. Suppose, for example, a user graduated from a university in Los Angeles, married, and moved to New York a few months ago. Imagine that a personalized news Web application that he frequently uses keeps wishing him a good morning at 2 PM New York time, promotes new store locations in Los Angeles, shows weather and traffic alerts for the Los Angeles area, and invited him to nightly Los Angeles area singles events. It is very conceivable that the user gets annoyed with the personalization in this news application and stops using it. It is important, therefore, that a personalization programming platform regenerates the application's user interface whenever a user launches the application and that the personalization process uses a recent version of the user's profile.

Public social networks typically require explicit user approval before an application is allowed to retrieve the user's profile through the social network API. Thus, user authentication in the social network and authorization for profile access is one common requirement for the type of personalization that the platform is intended to support and should therefore be implemented by the platform. Developers can restrict access to an application to a specific set of users. For example, a personalized web application may be accessible from the public Internet but may be meant to serve only the employees of a specific enterprise. Furthermore, the platform should support an explicit user login into an enterprise portal, and the explicit login can be personalizable as well. An explicit login allows the application to obtain more information about the user than would be possible with the user's social network profile alone. An example of such information is past transactions that the user had with the enterprise. The user can authenticate with the social network as part of an account creation process in connection with the application, or at the time of first use of the application, for example. In the event that a user does not desire to authenticate, the application can continue to operate and personalize, to the extent possible, using publicly available or indexable information, which does not require explicit authorization to access, from one or more social network service.

The personalization process can map user profiles to personalized application elements. Often, the desired personalization in Web applications affects only or mostly the application's user interface, rather than the structure or operation of the application backend which can also be affected based on a user's profile. The platform therefore focuses primarily on supporting the personalization of user interfaces and allowing developers to efficiently map user profile fields to personalized user interface elements. Personalization can affect the content, appearance, placement, size, functionality, and other attributes of virtually any user interface element. For example, user interface elements can be personalized for efficiency, or so that the user can achieve a particular task with as little effort as possible. Access to a user's social network profile allows deep insights into the user's persona. However, with this new potential for personalization comes the danger of a vastly increased effort to build Web applications. Imagine an application that generates a highly nuanced user interface element according to a combination of values from just a small subset of user profile fields, with a further simplification of the possible values of these fields:
Age: {under 21, between 21 and 50, over 50 years}
Gender: {female, male}
Language: {English, Spanish, French}
Relationship status: {married, single}
Employment status: {employed, self employed, not working}
Interests: {cars, books, electronics}
Education: {high school degree, college degree, post graduate degree}

Using this simplified set of example possible values, the application has the potential to generate nearly 1000 (3·2·3·2·3·3·3=972) unique user interface elements. Imagine further that the application should prominently display the user's name in various places and contain user location-specific elements. Developers face a problem of managing a combinatorial explosion of possibilities. One solution is to reduce the number of user profile fields according to which a given user interface element is personalized. Even then, however, the task of building personalized variations of the user interface can be daunting from a software engineering point of view. Based on these observations, heuristics can limit the complexity of mapping user profile fields to personalized user interface elements.

In many personalized web applications, the same personalization of an element often applies to a (large) group of users and not just to one individual user. In fact, considering the potentially very large number of users for a Web application, this situation is typical and not the exception. For example, if some content rendered by a Web application is to be personalized according to users' preferred languages and most users speak English, Spanish, or French, the application can segment its user base into three categories based on the language preference and for each segment provide one language-specific version of the content.

In many situations, non-personalized (undifferentiated) user interface elements will outnumber personalized elements in a given user interface. For example, the application provider may want to only personalize the user greeting and some product recommendations but leave all other elements, including fonts, color selection, navigation buttons, and the structure of the user interface undifferentiated for consistency purposes.

If the profile of a user does not contain the information that forms the basis for a personalized element, this element can default to a generic appearance, content, and functionality. Many users, for example, do not specify their age or birth date in their profiles. Generic defaults are also important in situations where personalization is intended only for a small subset of users. For example, if a retail chain wants to publicize the opening of a new store location as part of a Web application, it would make sense to only inform customers in the vicinity of the new location of the opening while others might see a generic marketing statement. Alternatively, the system can guess certain information about the user. For example, if the user has not entered a birth date, but has entered a high school graduation year, the system can reasonably reliably infer a relatively narrow range of possible birth dates, and consequently ages. The system can also infer a likely range of values for missing information for a particular user based on social network profile data of others, such as a spouse, children, or friends of the user.

Many types of personalization are simple variable substitutions in the user interface. An English user greeting in an e-commerce Web application, for example, might be generically expressed as “Hello, <userFirstName>, welcome to our online store!” and personalization would replace the <userFirstName> variable with the actual first name of the user. Personalization of a conditional JavaScript statement checking for the user's age might amount to substituting the <userAge> in “if (<userAge><18)” with the actual user's age.

Thus, the system can personalize according to user segments. Developers should be free to express arbitrary types of user segmentation and to do so without having to learn a special-purpose language. User segmentation can be optional, and without explicit segmentation, all users can be part of the same default user segment. The system can provide a fundamentally similar user interface for all users in the same segment, instead of a developer specifying different variations of one interface according to different user segments. The system can add fine-grain personalization down to individual users, extending the segment-specific interface.

The system can allow a developer or web site to specify user interface element defaults, with the option to define personalized values as deviations from the defaults based on user profile elements. As with user segmentation and for the same reason, developers can express arbitrary types of deviations from element defaults as well as specify an element default for each user segment or for all users.

The system can personalize user interfaces via variable substitutions or other suitable approaches. One alternate approach is to use a variable based on social networking data as a trigger to introduce, modify, remove, or rearrange user interface elements, functionality, and/or visible or non-visible interface attributes. The platform can offer a variable replacement mechanism that allows the arbitrary placement of variables in HTML pages, JavaScript code, and CSS specifications, and their substitution through default or personalized values, for example.

The system can incorporate a predefined set of standard variables, which can refer to the fields of the object that represent the user profile, such as name, age, gender, language, location, etc. Developers do not need to specify the values for standard variables as the system automatically replaces these values with the respective values in the user profile.

A second aspect of efficiency in mapping user profiles to personalized web application elements is run-time efficiency. Personalization of application elements can consume valuable time and hardware resources, and consequently longer application launch times, which can negatively affect the user experience. Further, the additional hardware resources can lead to increased equipment and operational expenses. Analogous to caching social networking profile data, the platform can cache all or some personalized elements for a specified time period so that repeat access to the application by the same user does not result in repeat work for the personalization platform.

To fulfill their intended functionality, many web applications access enterprise resources such as databases, files, enterprise resource planning (ERP) systems, customer relationship management (CRM) systems, communication servers, and reporting software. To protect against security attacks, these resources often reside on the application provider's internal network even if the Web application is available on the public Internet. The personalization programming platform must adhere to the established protection of enterprise resources. The platform itself, along with its ancillary resources such as configuration files, is a resource that should be protected and expose as little as possible of itself to the public Internet.

These approaches can shorten the personalization development cycle. Testing the personalization of a Web application often requires running the application under several different user identities and obtaining feedback about the personalization from different test users, which complicates and slows the application development process. To obtain the desired personalization, the development and test cycle may need to be repeated many times. Minimizing application recompilation and deployment steps therefore can decrease developer time. In more technical terms, this approach can maximize the opportunities for developers to define user interface personalization in the interpreted Web development and configuration languages HTML, JavaScript, CSS, and XML, with an automatic reload of changed files and propagation of changes through the system. The automatic reload and propagation affects the caching mechanisms. More complex personalization should be supported by an API, such as a Java API, and changes to the personalization code may require recompilation and redeployment.

User interface designers can specify personalization. Some web designers are reluctant to code in a general-purpose application programming language such as Java but feel comfortable coding in the Web development languages HTML, JavaScript, and CSS, and using XML. The reluctance may be due to a lack of exposure to Java. To better support the division of labor into user interface and backend development, user interface developers who do not have the necessary Java skills can specify as much of the user interface personalization as possible using what are traditionally web technologies, and without having to code in Java, C++, or C#, for example.

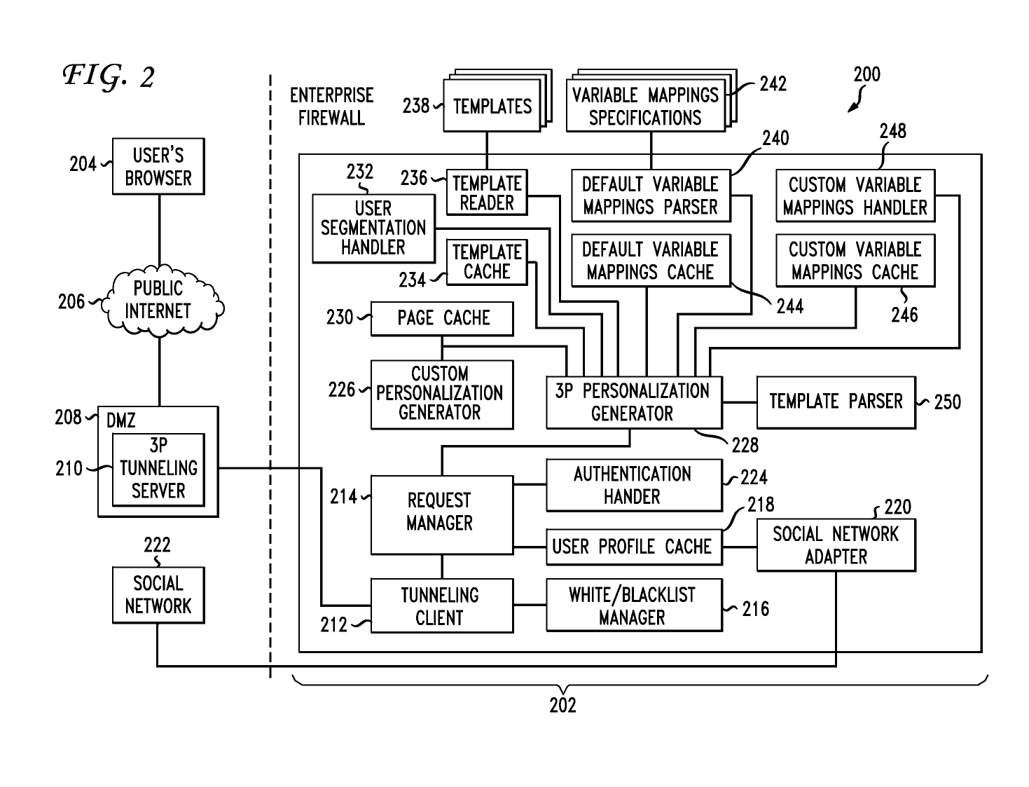

FIG. 2 illustrates an example architecture 200 and operation for a personalization programming platform (3P). An exemplary sequence of events that take place when a user interacts with a personalized 3P web application 202 outlines the function of the various 3P components and their interplay. The 3P components' functions are not confined to any specific application domain or purpose.

Certain components 210, 212, 214, 216, 218, 220, 228, 230, 234, 236, 240, 244, 246 250 are part of 3P, whereas other components 226, 224, 232, 238, 242, 248 can be supplied by the application developer. This example architecture contains a small Java API of four simple Java interfaces that allow the developer to customize 3P by providing the other components inside the 3P boundary 202. A 3P application is an extension of 3P and starts its own copy of 3P. Therefore, the other components in FIG. 2 are specific to a particular personalized web application. In the description of events, the application is assumed to be accessed via a user's browser 204 from the public Internet 206 and not from an enterprise Intranet. Access from an Intranet would connect the user's browser 204 directly with the 3P request manager 214 214 instead of traveling through the tunneling server 210 and Client 212.

The tunneling server 210 can be deployed in the enterprise demilitarized zone (DMZ) 208 as a DMZ conduit for all HTTP requests from the user's browser 204 to the 3P application 202 and does not contain any code or resources specific to a personalized web application. The tunneling server 210 allows the placement of all other 3P components and of the personalized web application and its resources on the private enterprise network and therefore protects them against direct access from the public Internet 206.

3P can start by launching the tunneling server 210 first and then the other 3P components on the enterprise network. The tunneling client 212 establishes a secure TCP connection to the tunneling server 210 through the enterprise firewall. The tunneling server 210 can transmit a periodic heartbeat signal to the tunneling client 212 over this connection. Upon signal receipt, the tunneling client 212 returns the signal to the tunneling server 210. If the tunneling client 212 does not receive the signal within a specified time window, it will attempt to re-establish the connection with the tunneling server 210 until it succeeds. If the tunneling server 210 does not receive the expected response to its heartbeat signal within a specified time window, it returns to a standby mode where it waits for the tunneling client 212 to re-establish the secure TCP connection. During this time, the tunneling server 210 responds to HTTP requests for the application with a specified default HTML page that indicates application unavailability. This way, the tunneling server 210 and tunneling client 212 automatically tolerate firewall outages, hardware reboots, 3P component restarts, and other intermittent failures or maintenance tasks.

Before continuing with the description of the tunneling mechanism, the discussion turns briefly social network authentication and authorization mechanisms. OAuth is one popular JavaScript-based authentication and authorization protocol in social networks, and the examples assume that the social network 222 uses OAuth. However, other suitable replacements for OAuth can be substituted. The tunneling server 210 can load an HTML page with customized OAuth JavaScript code and return it to the user's browser 204 at application launch. Through the HTML page, the user can log authenticate with the social network 222 if she is not already logged in, and authorize the application to retrieve her user profile from the social network 222 via OAuth or other API calls. OAuth then generates a token that, along with the user's social network identifier, can be passed to 3P as an HTTP request parameter.

After the authentication and authorization step, the HTML page redirects to 3P. The resulting HTTP request travels through the public Internet 206 and arrives at the tunneling server 210. The tunneling server 210 informs the tunneling client 212 through the secure TCP connection of a new HTTP request for the application. The tunneling client 212 opens a new, secure TCP connection to the tunneling server 210, and the tunneling server 210 creates a new thread that forwards the HTTP request to the tunneling client 212 over the newly established TCP connection. This connection remains open until the tunneling client 212 has sent a response to the HTTP request back to the tunneling server 210. This mechanism ensures that the tunneling server 210 can receive and forward new HTTP requests while others are being processed by 3P. The tunneling client 212 also creates a session object, and 3P can add string properties to it at any time. The session object is part of the response that the tunneling client 212 eventually sends back to the tunneling server 210. The tunneling server 210 translates this object into an HTTP session that 3P uses in subsequent HTTP requests to identify the user and maintain other session state. To this end, the tunneling server 210 retrieves the session object from the HTTP session and sends it along with any new HTTP request to the tunneling client 212.

The tunneling client 212 forwards every HTTP request for the application to the request manager 214 214. The request manager 214 orchestrates the processing of each request through various 3P components. The request manager 214 retrieves any HTTP request parameters and the current session object that the tunneling client 212 created or obtained from the current HTTP session. At application launch, the request manager 214 adds the user's social network identifier and access token to the session object for use in future requests from the same user, thereby obviating the need for repeat invocations of the authentication handler 224. The request manager 214 checks whether the user is authorized to access the application via the white/blacklist manager 216 and/or the authentication handler 214. The request manager 214 obtains the user's social network profile from the user profile cache 218, if any, and invokes the personalization generators 226, 228. Eventually, one of the personalization generators 226, 228 returns a string that represents a personalized HTML page, JavaScript code, or CSS specification. The request manager 214 returns this string to the tunneling client 212, from which the string travels back to the user's browser 202 through the tunneling server 210 and the Internet 206.

3P can be configured to check application users against a whitelist or blacklist via a white/blacklist manager 216. The request manager 214 forwards HTTP requests for launching the application to the white/blacklist manager 216 216. If the application provider wants to restrict access to the application to a group of provisioned users, the white/blacklist manager 216 checks whether the user's social network identifier is included in the whitelist. If not, the request manager 214 returns an error message to the user and/or can simply fall back on default values or an unpersonalized interface. If the application provider wants to exclude certain individuals from accessing the application, the white/blacklist manager 216 checks whether the user's social network identifier is included in the blacklist. If so, the request manager 214 can return an error message to the user or simply return the non-personalized version of the website. A whitelist or blacklist can be a file, a database table, or a web service. The whitelist or blacklist can be based on components of a social networking profile instead of a predetermined list of specific social networking accounts. For example, if the name listed in the social network profile includes profanity, then the blacklist can block that entire social network profile or just specific parts.

If the user has cleared the optional check performed by the white/blacklist manager 216, the request manager 214 will instruct the user profile cache 218 to retrieve the user's social network profile. If the user profile cache 218 detects a cache miss, it retrieves the profile from the social network through the social network adapter 220. The social network adapter 220 can be implemented according to the API of one or more public or private social network. After the social network profile is retrieved, the social network adapter 220 creates an object whose fields represent the entries of the user's profile. The object is then stored in the user profile cache 218.

When the user profile cache 218 reaches its configured capacity for storing entries, it can evict cache entries based on a least recently used strategy or other appropriate cache management algorithm. For example, the user profile cache 218 can employ a check-pointing mechanism to tolerate 3P reboots without the need for re-fetching previously cached user profiles. Cache entries can expire after a specified time period, such as a few days or some other period. This approach can expedite repeat accesses to the user's social network profile.

3P can offer the application provider the option of adding an explicit user login into an enterprise security system. If 3P is configured for an explicit user login, the request manager 214 can instruct the personalization generator 228 to return a dedicated, personalized login HTML page. The process for producing the login page is exactly the same as for any other personalized HTML page that is part of the application. When the user submits her enterprise account credentials through the login HTML page, the request manager 214 eventually routes the resulting HTTP request to the authentication handler 224. The 3P API can include a simple interface that the authentication handler 224 implements. The authentication handler 224 interacts with the specific enterprise security system in order to verify a match between the user-supplied account name/password combination and the user credentials stored in the enterprise security system.

The application developer can build a custom personalization generator 226 that assembles a personalized response to an HTTP request. The 3P API can include an interface that the custom personalization generator 226 implements. If a custom personalization generator 226 is deployed, the request manager 214 invokes it with the HTTP request, current session object, and the user's social network profile as parameters. For example, the user interface of the application may contain AJAX code that dynamically updates a <div> in the user interface with local weather information. To generate the updated <div>, the custom personalization generator 226 retrieves weather information for the user's location from a weather web Service, assembles an HTML snippet with the weather information in the user's preferred language, and returns the HTML snippet as a string to the request manager 214.

If no custom personalization manager 226 is deployed or if it returns a null response, indicating it does not or is unable to handle the current HTTP request, the request manager 214 calls the 3P personalization generator 228 with the current HTTP request, session object, and the user's social network profile as parameters. The 3P personalization generator 228 orchestrates the assembly of personalized HTML pages, JavaScript code, and CSS specifications, for example, and returns them to the request manager 214. First, the 3P personalization generator 228 checks whether the requested object exists in the page cache 230. If so, the 3P personalization generator 228 returns the cached object to the request manager 214. If not, it uses the services of various subcomponents to generate a personalized HTML page, JavaScript code, or CSS specification, for example, and stores it in the page cache 230, and returns it to the request manager 214.

The page cache 230 can store previously generated personalized HTML pages, JavaScript code, and CSS specifications. Whenever application resources change (HTML, JavaScript, or CSS templates) that affect the previously generated entries in the page cache 230, the 3P personalization generator 228 can automatically clear the page cache 230, thereby forcing a subsequent on-demand regeneration of its previous entries. If the 3P process is in danger of running out of memory, the page cache 230 can delete all or some of its entries automatically, such as based on a desired threshold level of available memory. The page cache 230 can accelerate the generation of personalized HTML pages, JavaScript code, CSS specifications, and other user interface elements.

Personalization in 3P can involve several 3P components. The 3P personalization process can instantiate HTML, JavaScript, and CSS templates and return instantiated HTML pages, JavaScript code, and CSS specifications to the request manager 214. A template can include a parameterized HTML page, JavaScript code, or CSS specification. A template differs from a non-parameterized version only in the use of 3P variables of the form _@<variable name> that the application developer inserts in places where content, appearance, or functionality needs to be personalized. Thereby, 3P allows the application programmer to continue developing the customary HTML pages, JavaScript code, and CSS specifications for a Web user interface.

Excerpt 1, below, shows a very simple example of parameterization in an HTML page, thus yielding an HTML template. Excerpt 1 demonstrates eight variables: _@brandingClass, _@businessName, _@businessPageUrl, _@hover, _@hoverText, _@logoUrl, _@greetingClass, and _@greeting. The variables _@brandingClass and _@greetingClass allow the personalization of the CSS classes that determine the appearance of the two table cells. Note that the CSS class specifications themselves can be parameterized and therefore personalized in a CSS template or a style entry in this HTML template. During the personalization process, _@businessName and _@greeting are substituted with personalized content. For example, the business may appear under different names in different geographic regions, and the greeting can be made language and time-specific (“Good evening, Jane!”, “Hola, Juan.”, or “Bonjour, Francoise.”). The @businessPageUrl and @logoUrl are substituted with URLs that may change based on characteristics of the user such as location, language, age, gender, affiliations, income, etc. For the female customer, for example, the _@businessPageUrl may point to a Web page of the business that focuses on products for women. Lastly, _@hover and _@hoverText exemplify how JavaScript can be parameterized and personalized as well. The _@hover variable will be replaced with the name of an actual JavaScript function that itself can be parameterized, and _@hoverText determines what personalized parameter is being passed to the _@hover function.

Excerpt 1

```
<td id=“branding” class=”_@brandingClass”>
    <div>_@businessName</div>
    <div>
        <a href=”_@businessPageUrl”
onmouseover=”_@hover(‘_@hoverText’);”>
            <img src=”_@logoUrl” height=”48” width=”48”>
        </a>
    </div>
</td>
<td id=”greeting” class=”_@greetingClass”>
    <div>_@greeting</div>
</td>
```

When the user launches the application, the variables in the templates need to be replaced with actual values. There are two possible sources for the actual values: one is a collection of default values. The other is a set of dynamically generated personalized values for this user that override the default values or replace variables for which no default value has been specified. Default values are stored in an XML variable mappings specification containing mappings from template variables to default values. Excerpt 2, below, shows a simple mapping from the _@greeting variable to a default value for English-speaking users, the HTML snippet <h4> Welcome to your Acme shopping portal.</h4>.

Excerpt 2

<greeting><![CDATA[‘<h4> Welcome to your Acme shopping
portal.</h4>’]]>
</greeting>

Excerpt 3, below, shows a slightly more complicated example. Here, the default value <h4>Hello, _@firstName! Welcome to your Acme shopping portal.</h4> itself contains another variable _@firstName. Default and personalized values may contain standard variables that correspond to values in the user's social network profile object. The _@firstName variable is a standard variable that is automatically replaced with the first name in the user's social network profile.

Excerpt 3

<greeting>
<![CDATA[‘<h4>Hello, _@fisrtName! Welcome to your Acme
shopping portal.</h4>’]]>
</greeting>

If the developer omits a mapping from _@greeting to a default value in the variable mappings specification or wishes to override the default value for some users with more personalized values, a 3P Java handler can generate, among other things, the substitution for the _@greeting variable. By inspecting the first name, language preference, and time zone, the handler can, for example, map _@greeting to <b>Good evening, Jane! Welcome to your personalized Acme shopping portal.</b>. Excerpt 4, below, shows an excerpt from a 3P Java handler producing the greeting for an English-speaking user after 6:00 PM (18:00 hours).

A handler that generates more creative greetings could, for example, inspect the user's work and education history, hobbies, and activities, in addition to the first name, language preferences, and time zone. Suppose, for example, that the work and education history suggests that a user has a high income and the hobbies and activities indicate an interest in home audio equipment. The handler could then generate a greeting such as _@firstName, welcome to Acme, your personal high-end <a href=“http://www.acmeportal.com/highEndAudio.html”>audio equipment heaven.</a>.

Excerpt 4

```
Public VariableSubstitutions getPoersonalizedVariableSubstitutions (User
userProfile, HttpServletRequest req)
{
    final VariableSubstitutions variableSubstitutions = new
VariableSubstitutions( );
    final int timezone = userProfile.getTimezone( );
    final String language = userProfile.getLanguage( );
    int hours;
    if (timezone >= 0) hours =
Calendar.getInstance(TimeZone.getTimeZone(“GMT+” +
timezone)).get(Calendar.HOUR_OF_DAY);
    else hours =
Calendar.getInstance(TimeZone.getTimeZone(“GMT+” +
timezone)).get(Calendar.HOUR_OF_DAY);
    if (hours > 18)
        if (language.equals(“en”))
variableSubstitutions.addVariableSubstitution(“_@greeting”, “<b>Good
evening, “ + userProfile.getFirstName( ) + “! Welcome to your Acme
shopping portal.</b>”);
        else if (language.equals(“es”))
variableSubstitutions.addVariableSubstitution(“_@greeting”, “<b>Buenas
noches, “ + userProfile.getFirstName( ) + “! Bienvenido a tu portal de
compras por Acme.</b>”);
}
```

Excerpt 5, below, illustrates a hybrid approach in 3P where the variable substitution is a combination of a default and a personalized value. Here, the variable _@timeOfDay in the variable mapping is not a standard variable because it does not reference a field in the user's social network profile, and the variable mappings specification does not map it to a default value. Instead, it can be replaced with a dynamically computed, personalized value by the aforementioned Java handler.

Excerpt 5

<greeting>
<![CDATA[‘<h4>_@timeOfDay, _@fisrtName! Welcome to your
Acme shopping portal.</h4>’]]>
</greeting>

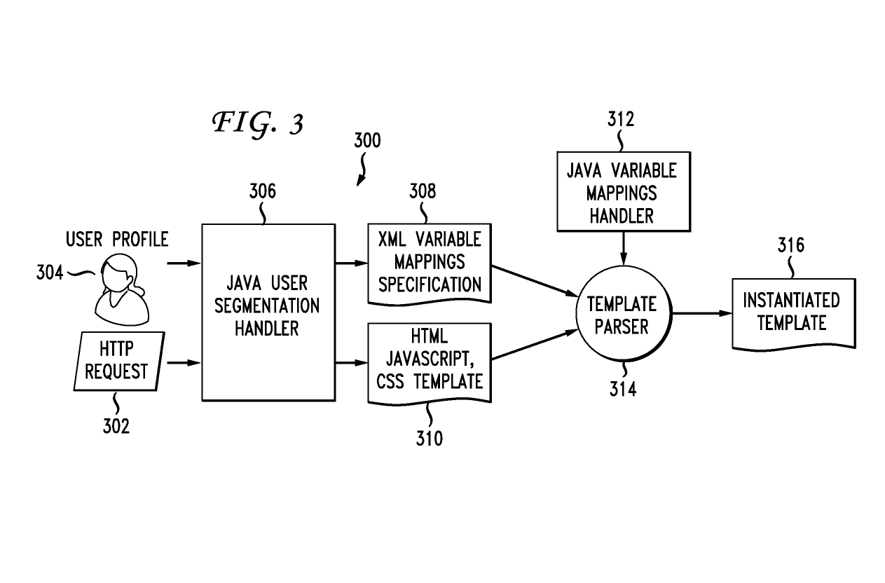

Simple personalization that relies exclusively on the values in the user's social network profiles can be performed without the need for writing any Java code. More elaborate personalization, exemplified by the dynamically generated _@greeting and _@timeOfDay variable substitutions above, requires writing some Java code in the form of the custom variable mappings handler 248. FIG. 3 illustrates an exemplary flow 300 for performing personalization and shows the interplay of the components that performs the substitution of template variables with default or personalized values.

Another personalization mechanism that can require some Java code, the User Segmentation Handler 306, assigns users to different user segments based on an input user profile 304 and an http request 302. Each segment has a corresponding set of templates 310 and a variable mappings specification 308. The User Segmentation Handler 306 can be completely separate from the template personalization and requires infrequent, if any, updates even if the templates change significantly. In excerpts 2, 3, and 5, for example, variable mappings are specific to the segment of English speaking users. The programmer can decide how much content the application produces through user segmentation, templates, and variable mappings specifications, versus through generating personalized values. While the above examples made heavy use of segmentation, templates, and variable mappings specifications, it is possible to go to the other extreme. Here, the entire template consists of only one variable, say _@content, and the Custom Variable Mappings handler would dynamically generate the entire substitution value for _@content.

The application developer can implement a User Segmentation Handler 306 according to the 3P API. The Handler 306 receives an HTTP request 302 and at least part of the user's social network profile 304 as parameters and maps them to a tuple (template URI, variable mappings URI). The template URI references an HTML, JavaScript, or CSS template. The variable mappings URI references an XML specification of the mappings from template variables to default values. Both URIs can point to the local file system or to an arbitrary Web server. In other words, the User Segmentation Handler 306 assigns each user to a set of templates and variable mappings, thereby implicitly placing users in different segments.

For example, user segmentation may be desired along language lines and so the developer can provide three different HTML templates for each page in the application's Web user interface, one in English, one in Spanish, and one in French. For each of the three templates the developer builds a variable mappings specification 308 that contains default values for personalization variables in the template. The User Segmentation Handler 306 determines the user's preferred language from the user's social network profile and returns a tuple that points to the language-specific template and the associated variable mappings specification 308. A template parser 314 takes the inputs from the variable mappings specification 308, the template 310, and the variable mappings handler 312 to generate an instantiated template 316 as output. Excerpt 6, below, shows an excerpt from a User Segmentation Handler that performs segmentation according to users' language preferences.

Excerpt 6

```
Public UserSegmentMapping getUserSegmentMapping(User userProfile,
HttpServletRequest req)
{
    final UserSegmentMapping userSegment = new
    UserSegmentMapping( );
    if (userProfile.getLanguage( ).equals(“en”))
    {
        userSegment.setTemplateFileUri(“C:\\acmePortal\\csw\\
    enService Template.html”);
        userSegment.setVariableMappingsFileUri(“C:\\acmePortal\\csw\\
    enVariableMappings.xml”);
    }
    else if (userProfile.getLanguage( ).equals(“es”))
    {
        userSegment.setTemplateFileUri(“C:\\acmePortal\\csw\\
    esService Template.html”);
        userSegment.setVariableMappingsFileUri(“C:\\acmePortal\\csw\\
    esVariableMappings.xml”);
    }
}
```

When the User Segmentation Handler 306 is implemented in Java or similar language, any changes to it may lead to recompiling the application. If the application developer does not provide a User Segmentation Handler 306, the 3P personalization generator 228 will use a default URI tuple, thus assigning all users to the same user segment. On the other hand, the User Segmentation Handler 306 can create a different user segment for each user although practically this would only make sense if the number of provisioned users were extremely small.

Once the User Segmentation Handler 306 has computed the URI tuple for the template and the variable mappings specification, the 3P personalization generator 228 searches the template cache 234 for the specified template. In case of a cache miss of a template with a URI that points to the local file system, the 3P personalization generator 228 instructs the template reader 236 to read the template file from the file system and stores the template in the template cache 234. If there is no cache miss, the 3P personalization generator 228 checks whether the template file has changed since it was last cached. If so, the template reader 236 retrieves the newer template file and stores it in the template cache 234. In this case, the 3P personalization generator 228 invalidates all entries in the page cache 230 and forces a regeneration of all content that the application user interface requests from then on. It would be too time-consuming to track which page cache 230 entries are based on a given template, thus a complete removal of all entries in the page cache 230 can be preferable. Likewise, the 3P personalization generator 228 can force a reload of the variable mappings specification, re-store it in the Default Variable Mappings Cache 244, and invalidate the page cache 230 entries if the variable mappings specification has changed after its last caching.

If the template URI points to a Web server, the Template Reader 236 loads the template from the server, regardless of previous retrievals, because the server may generate a new or modified template each time. The page cache 230 therefore does not store templates retrieved from Web servers. Hence, caution has to be applied when specifying Web template URIs.

The 3P personalization generator 228 searches the Default Variable Mappings Cache 244 for the variable mappings specification referenced by the (template URI, variable mappings specification URI) tuple that the User Segmentation Handler 232 had returned. In case of a cache miss, the 3P personalization generator 228 instructs the Default Variable Mappings Parser 240 to retrieve the XML specification from the file system or a Web server. The Default Variable Mappings Parser 240 then parses the XML specification into (variable name, default value) tuples and stores them in a hash table that it caches for future use and returns to the 3P personalization generator 228. The XML specification in excerpt 3, for example, would be parsed into the tuple (“_@greeting”, “<h4>Hello, _@firstName! Welcome to your Acme shopping portal.</h4>”).

The application developer may also provide a Custom Variable Mappings Handler 248 which implements a 3P Java API interface and substitutes variables in templates with personalized values. Personalized values either override default values returned by the Default Variable Mappings Parser 240 and/or the Default Mappings Cache 24 or replace variables that have no such default value. The 3P personalization generator 228 invokes the Custom Variable Mappings Handler 248 with the user's social network profile and the HTTP request as parameters. The Handler 248 returns a hash table containing mappings from template variables to personalized values. The hash table is stored in the Variable Mappings Cache 244 for future requests from the same user. Excerpt 4 illustrates an passage from a simple exemplary Custom Variable Mappings Handler 248.

The Template Parser 250, 314 joins an HTML, JavaScript, or CSS template 310 with the default and custom variable mappings to produce an instantiated HTML page, JavaScript code, or CSS specification 316. The template parser 250, 314 receives the template, the hash table with variable mappings returned by the Custom Variable Mappings Handler 248, and the hash table with default variable mappings returned by the Default Variable Mappings Parser 240 as input parameters from the 3P personalization generator 228. For each variable of the form _@<variable name> that the parser 240 finds in the template, the Template Parser 240 looks up the personalized variable mappings hash table for a custom value. If such a value exists, the Template Parser 240 replaces the variable with the custom value. Otherwise, the Template Parser 240 retrieves the default value from the hash table with default variable mappings and replaces the variable with the default value.

The Template Parser 240 can make one or more passes over the template. In one example implementation, the template parser 240 makes two passes over the template. As excerpts 3 and 5 demonstrate, a variable may be substituted with a value that contains another variable. Hence, after the first pass some variables may not be completely resolved to actual values, and the Template Parser 240 substitutes these variables with actual values in the second pass. Eventually, the Template Parser 240, 314 returns the instantiated file 316 to the 3P personalization generator 228.

The design of 3P can be illustrated by a set of personalized web applications called customer service widgets (CSWs). A business can deploy a CSW on a social network page to provide software-assisted, personalized customer service. The CSW helps establish live conversations between social network users and customer service representatives (agents) through voice, video, or text chat. The CSW offers access to a business knowledge base containing reported issues and solutions to help customers troubleshoot their problems with business products and services. The CSW can display news about the business, current promotions, coupons, marketing information, etc., all tailored to the customer and his or her presumed needs and interests. CSWs can assist in modernizing legacy customer service technologies and bringing customer service to social networks. Developers can build CSWs on 3P.

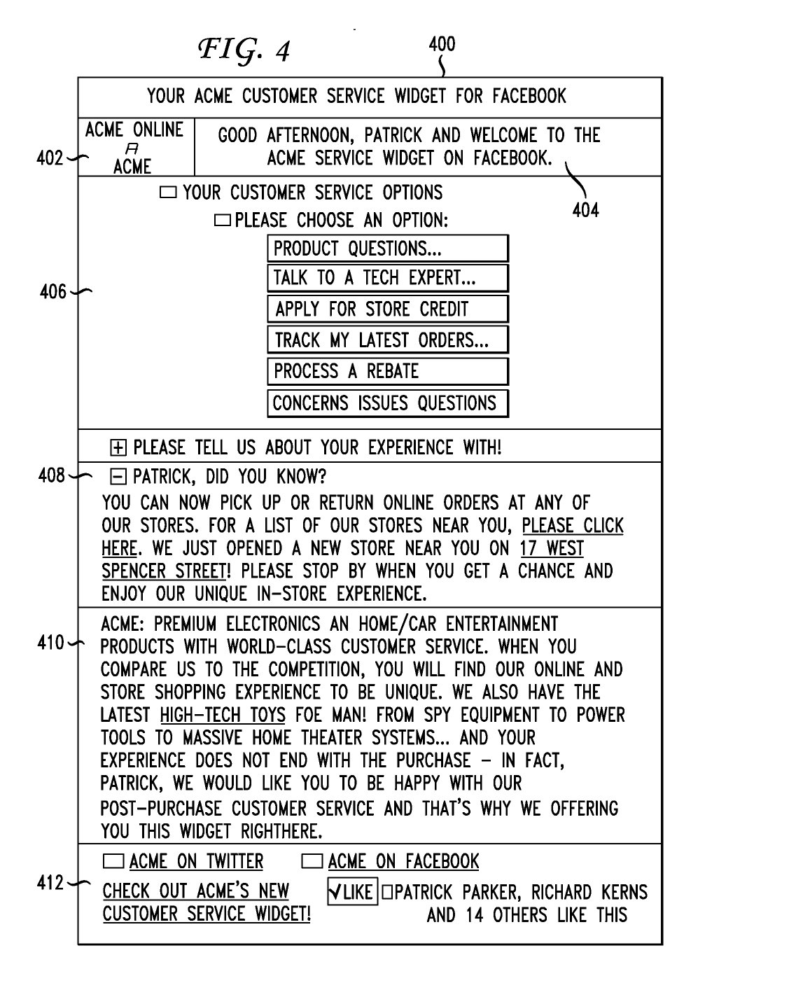

FIG. 4 illustrates an example personalized customer service widget (CSW) 400, which demonstrates how 3P can enable personalization in CSWs. In the example, a fictitious business by the name of Acme posts a hyperlink to the 3P tunneling server 210 on its Facebook page. The 3P social network adapter 220 for the CSW application is tailored to the Facebook API. The CSW consists of one main HTML page containing AJAX code for dynamically updating various portions of the CSW user interface and two ancillary HTML pages, not shown in FIG. 4.

The CSW 400 in FIG. 4 was generated for a user by the name of Patrick. His Facebook user profile indicates that Patrick is male, English-speaking, lives in Denver, Colo., has an avid interest in consumer electronics of various kinds, is well-educated with a degree in electrical engineering, is middle-aged, and is presumably somewhat affluent, based on his employment history and current employment status. The CSW application can use the various personalization mechanisms in 3P to influence the appearance, content, and functionality of the CSW for Patrick. The application performs user segmentation along language lines, as shown in excerpt 6. Patrick speaks English, and so the CSW is rendered in this language. For each of the supported languages, there is one set of HTML templates in the Acme CSW application. One of the variables in all HTML templates for this CSW is _@fontSize for various <div> elements. The font size is selected dynamically in a Custom Variable Mappings Handler depending on the age of the customer: older customers see larger fonts to facilitate reading the CSW content. For an example of a Custom Variable Mappings Handler. The greeting 404 is generated as a combination of a default variable mapping and a personalized value. If today is the customer's birthday, the greeting changes to a birthday congratulation. Further, the CSW can ‘brand’ the output with a logo or other mark 402. The Custom Variable Mappings Handler can personalize the customer service menu 406 according to the customer's gender, interests, and perceived affluence. Like the greeting 404, the business information 408 is generated through a combination of a default variable mapping and personalized values produced by the Custom Variable Mappings Handler. In place of the content that we see next to the business information 408, the HTML template contains the variable _@businessInfo. The default variable mapping for _@businessInfo can include three sentences. The first sentence (You can now pick up or return online orders at any of our stores.) is a stock sentence that all English-speaking customers see. The second sentence (For a list of our stores near you, please <a href=“http://www.acmeportal.com/dspLoc?location=_@location” target=“_blank”>click here</a>.) contains the standard variable _@location that references the location field in the customer's social network profile. The third sentence is simply the variable _@customerSpecificContent that the Custom Variable Mappings Handler substitutes with an actual value. Here, the Handler determines that Patrick lives near a new Acme store location on 17 West Spencer Street and informs Patrick accordingly. Like the business information 408, the marketing statement 410 can be partially based on default values and partially on a personalized value. The Custom Variable Mappings Handler can generate the second sentence based on the fact that Patrick is male, interested in consumer electronics, and somewhat affluent. The Custom Variable Mappings Handler can also generate a social network encouragement section 410 which can be tailored to show the social networks with which the user is registered, affiliated, or otherwise expected to be interested in. In this example, this section 410 includes Twitter and Facebook.

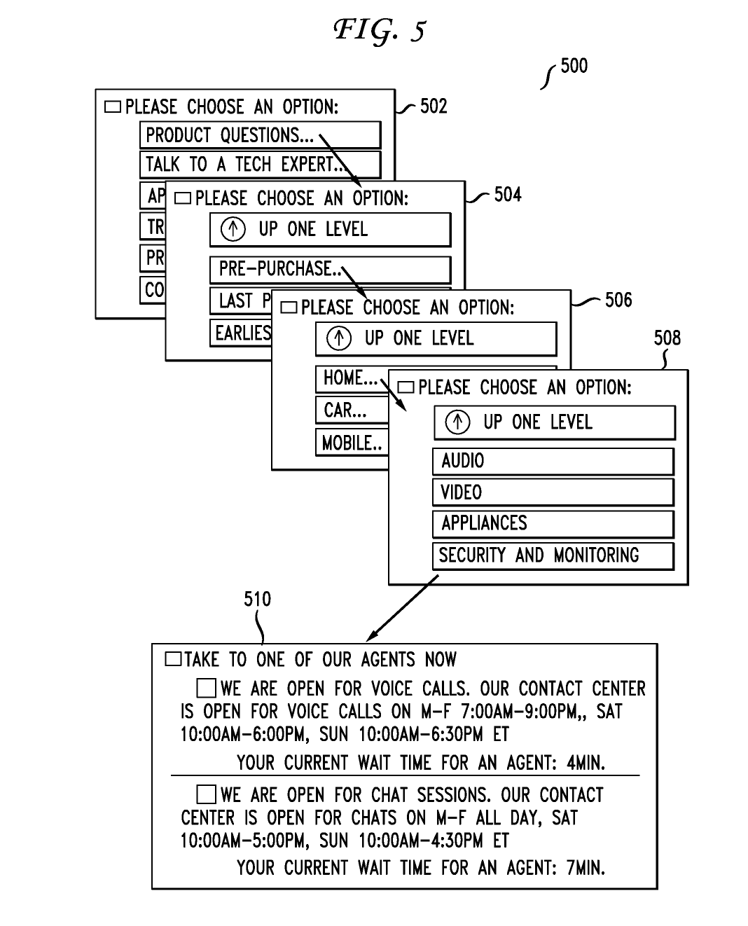

FIG. 5 illustrates a flow 500 for navigating an example personalized customer service menu 406, as shown in FIG. 4. Patrick can drill down in the customer service menu 406 and the displayed options on each level 502, 504, 506, 508, 510 can be at least partially determined by what the business thinks Patrick might be most interested in. In contrast, a customer with a strong interest in cars rather than consumer electronics might see a customer service menu that prominently shows entries related to car accessories. When Patrick clicks on any of the menu options Audio, Video, Appliances, or Security and monitoring 508, a personalized selection of modalities (voice, chat) 510 for communicating with an Acme agent pops up in the CSW. Because a video connection to an agent incurs additional cost for Acme, the system can only offered this option to high-profile customers, for example, and not to Patrick. The expected wait times for an agent shown in the popup 510 can be personalized as well. Patrick's position in the call queue and thus his expected wait time can be partially determined by his perceived value as a customer to Acme.

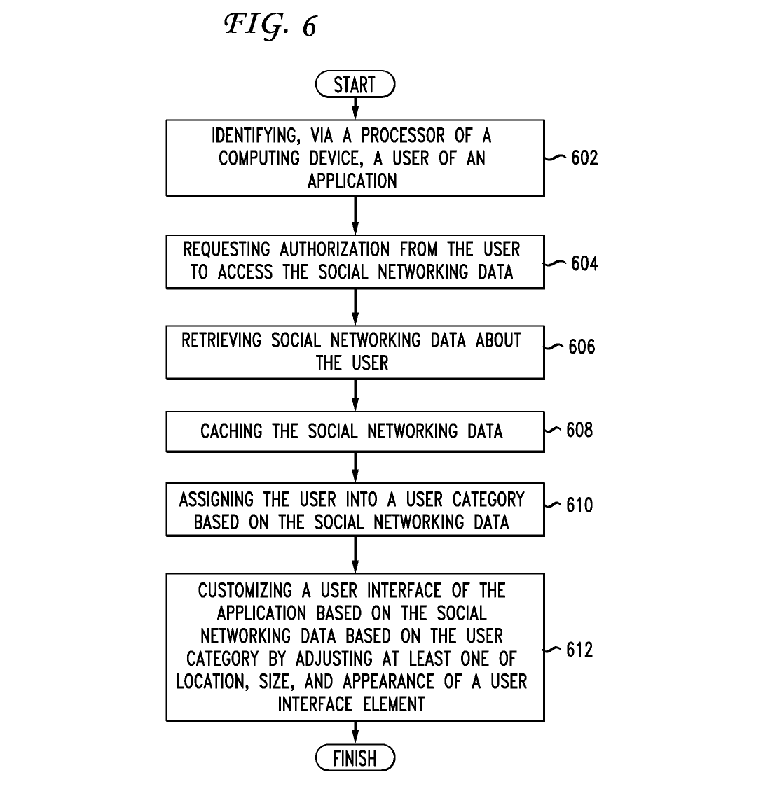

Having disclosed some basic system components and concepts, the disclosure now turns to the exemplary method embodiment shown in FIG. 6. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps. The system first identifies a user of an application (602), such as by requesting the user to log in to or create a user profile. Alternatively, the system can identify the user based on a cookie, an existing session, a browser ‘fingerprint’ that uniquely identifies a particular browser, a network address, other identifying information, and/or a combination thereof.

The system optionally requests authorization from the user to access the social networking data (604), such as if all or part of the social networking data is private. The system can request this authorization when a user creates a user profile, for example, and rely on that authorization for subsequent personalization efforts. The system can also request this authorization from the user upon the first attempt by the system to personalize the user interface. The system retrieves social networking data about the user (606), such as through a social network API, cache, a ‘scraper’ that extracts information from a publicly available social networking source, and/or social networking aggregator. Other sources of information can also be used. When the system receives this social networking data, it can proceed to cache the social networking data (608) in order to save on bandwidth and/or to keep traffic or requests within the terms of service of a social networking API.

The system can assign the user into a user category based on the social networking data (610), and customize a user interface of the application based on the social networking data and/or the user category by adjusting at least one of location, size, and appearance of a user interface element (612). The user interface element can be a non-advertising layout element including text, font, font size, an image, a color, a thickness, position, arrangement, orientation, transparency, and/or any other attribute of a displayable user interface element. The system can customize the user interface by mapping custom variables based on the social networking data.

The programming platform 3P for personalized web applications. 3P is based on the idea of obtaining detailed information about application users from a public or private social network where a plethora of such information is stored in the form of user profiles. The 3P approach therefore complements existing personalization technologies that automatically collect information about users while users interact with the application or explicitly prompt users for information. The 3P programming model enables developers to easily incorporate personalized elements in an application based on retrieved user profiles. The main goals of 3P are utmost simplicity of learning and using the platform, as well as general applicability of the platform to all types of personalized web applications. We described the set of goals for 3P and showed how its architecture meets these goals. We have developed several real personalized web applications on 3P that we call customer service widgets, and we illustrated the use of 3P through a sample customer service widget. Some challenges remain to be met by 3P. Among them is a lack of a development environment that would assist the developer in building XML default variable mappings specifications. Currently, this is a tedious manual task. We also want to refine and validate the 3P design by broadening the class of applications that we have built with 3P. At this time, all 3P applications that were built are customer relationship management or enterprise information applications.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. ̂$ that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
identifying, via a processor of a computing device, a user of an application;
retrieving social networking data about the user; and
customizing a user interface of the application based on the social networking data.

2. The method of claim 1, wherein the social networking data is publicly available.

3. The method of claim 1, wherein the social networking data is private, the method further comprising:
requesting authorization from the user to access the social networking data.

4. The method of claim 1, further comprising:
caching the social networking data.

5. The method of claim 1, wherein customizing the user interface comprises mapping custom variables based on the social networking data.

6. The method of claim 1, further comprising:
assigning the user into a user category based on the social networking data; and
customizing the user interface further based on the user category.

7. The method of claim 1, wherein customizing the user interface of the application further comprises:
adjusting at least one of location, size, and appearance of a user interface element.

8. A system comprising:
a processor;
a memory having stored therein instructions for controlling the processor to perform steps comprising:
identifying, via a processor of a computing device, a user of an application;
retrieving social networking data about the user; and
customizing a user interface of the application based on the social networking data.

9. The system of claim 8, wherein the social networking data is publicly available.

10. The system of claim 8, wherein the social networking data is private, the instructions further comprising:
requesting authorization from the user to access the social networking data.

11. The system of claim 8, the instructions further comprising:
caching the social networking data.

12. The system of claim 8, wherein customizing the user interface further comprises mapping custom variables based on the social networking data.

13. The system of claim 8, the instructions further comprising:
assigning the user into a user category based on the social networking data; and
customizing the user interface further based on the user category.

14. The system of claim 8, wherein customizing the user interface of the application further comprises:
adjusting at least one of location, size, and appearance of a user interface element.

15. A non-transitory computer-readable storage medium having stored therein instructions which, when executed by a computing device, cause the computing device to perform a method comprising:
identifying, via a processor of a computing device, a user of an application;
retrieving social networking data about the user; and
customizing a user interface of the application based on the social networking data.

16. The non-transitory computer-readable storage medium of claim 15, wherein the social networking data is publicly available.

17. The non-transitory computer-readable storage medium of claim 15, wherein the social networking data is private, the method further comprising:
requesting authorization from the user to access the social networking data.

18. The non-transitory computer-readable storage medium of claim 15, the method further comprising:
caching the social networking data.

19. The non-transitory computer-readable storage medium of claim 15, wherein customizing the user interface comprises mapping custom variables based on the social networking data.

20. The non-transitory computer-readable storage medium of claim 15, the method further comprising:
assigning the user into a user category based on the social networking data; and
customizing the user interface further based on the user category.
